(19) United States
(12) Patent Application Publication
(10) Pub. No.: US 2016/0306562 A1
(43) Pub. Date: Oct. 20, 2016

(54) Method for Managing an Electronic-Card Memory

(71) Applicant: MORPHO, Issy-Les-Moulineaux (FR)

(72) Inventors: Sofiane Cerbah, Issy-Les-Moulineaux (FR); Sylvain Jérôme Fromager, Issy-Les-Moulineaux (FR); Raphaël Geslain, Issy-Les-Moulineaux (FR); Cyrille Pepin, Issy-Les-Moulineaux (FR)

(21) Appl. No.: 15/130,029

(22) Filed: Apr. 15, 2016

(30) Foreign Application Priority Data
Apr. 17, 2015 (FR) 1553465

(51) Int. Cl. G06F 3/06

(52) U.S. Cl. CPC G06F 3/0608; G06F 3/0622; G06F 3/0631; G06F 3/0637; G06F 3/0679

(57) ABSTRACT

A method is proposed for managing a memory (2) of an electronic card (1), the electronic card (1) being able to execute a first program (P1) and a second program (P2), the method comprising steps of:
allocating (100), in the memory (2), a first memory space (D1) accessible to the first program (P1),
allocating (106), in the memory (2), a second memory space (C2) storing the code of the second program (P2),
detecting (112) a first data entry on instruction from the first program in the first memory space (D1),
release (114) of the second memory space (C2) in response to the detection (112).

### GENERAL FIELD

The present invention relates to a method for managing an electronic-card memory.

### PRIOR ART

An electronic card is known from the prior art, comprising a processor suitable for executing an operating system and a plurality of application programs—commonly referred to as applications—that cooperate with the operating system.

The electronic card comprises a memory to which the processor has access.

For each application, the program itself, whether it is in the form of compiled code or interpreted code, and in addition data written and/or read in the memory by the program during execution thereof by the processor, are stored in the memory. These data are, for example, user data, that is to say data associated with a particular user of the program.

The number of programs that can simultaneously be installed in the electronic card therefore depends on the storage size of the memory on the electronic card, which must be limited for cost reasons.

Each program, or application, is supplied by a publisher and provides a given service.

In electronic cards according to a first type, each program can be installed on command from a user of the card.

However, electronic cards according to a second type are not designed so that a user can himself demand the installation of such applications. The applications are then preinstalled in the memory of the card, during a configuration step in the factory, before any use of the card.

During this factory configuration step, it is possible that a plurality of applications supplied by competing publishers, providing the same service, may be preinstalled in the card memory. This pre-installation is required for a card of the second type. It is also possible for a card of the first type, in order to avoid the user having himself to install these applications or to encourage him to use these preinstalled applications.

For example, a plurality of applications of the banking type offering competing bank transaction services may be preinstalled in the memory.

However, since these competing applications provide the same service, it is probable that the user will use only one of them; some of the memory space of the electronic card is then consumed unnecessarily, and cannot be used for storing data related to the application that is actually used by the user.

### PRESENTATION OF THE INVENTION

One aim of the invention is to increase the memory space available in an electronic card having a predefined total memory space.

In order to achieve this aim, the invention proposes the method according to claim 1.

The first data entry in the first memory space means implicitly that the first program is of interest for the user of the electronic card. Consequently it is considered by the present invention that the second program providing the same service as the first program is probably without interest for this same user. The method automatically releases part of the memory unnecessarily consumed by the code of the second program. This part of the released memory then becomes available for other uses.

This method can also be supplemented by the following features, taken alone or in any one of the technically possible combinations thereof.

The first memory space may be accessible selectively to the first program.

The method may comprise a determination of information indicating whether or not the first program and the second program use an identical service, the release being selectively implemented if the information indicates that the two programs both use an identical service.

The identical service may be a bank transaction service.

The method may comprise a detection of any third program stored in the memory and configured to control execution of the second program, the release of the second space being selectively implemented if no third program is detected.

The method may also comprise the allocation, in the area of the memory made available by the release of the second memory space, of a third memory space accessible to the first program.

The invention also proposes a computer program product comprising program code instructions for executing the steps of the above method, when this program is executed by a processor.

The invention also proposes an electronic card comprising:
at least one processor suitable for executing a first program and a second program, the two programs implementing an identical service,
a memory comprising:
   a first memory space accessible to the first program,
   a second memory space storing the code of the second program,
      in which the processor is configured to:
detect a first data entry in the first memory space caused by the first program in the first memory space, and
demand the release of the second memory space in response to the detection.

The memory may be of the flash or EEPROM type.

Use of an electronic card according to the above as a personal authentication card is also proposed.

### DESCRIPTION OF THE FIGURES

Other features, aims and advantages of the invention will emerge from the following description, which is purely illustrative and non-limitative, and which must be read with regard to the accompanying drawings, in which:

FIG. 1 depicts schematically an electronic card according to one embodiment of the invention.

FIG. 2 is a flow diagram of steps of a method for managing the memory of the card depicted schematically in FIG. 1, according to one embodiment of the invention.

FIGS. 3 to 5 depict schematically the content of the memory of the electronic card at different stages of implementation of the method according to FIG. 2.

In all the figures, the similar elements bear identical references.

### DETAILED DESCRIPTION OF THE INVENTION

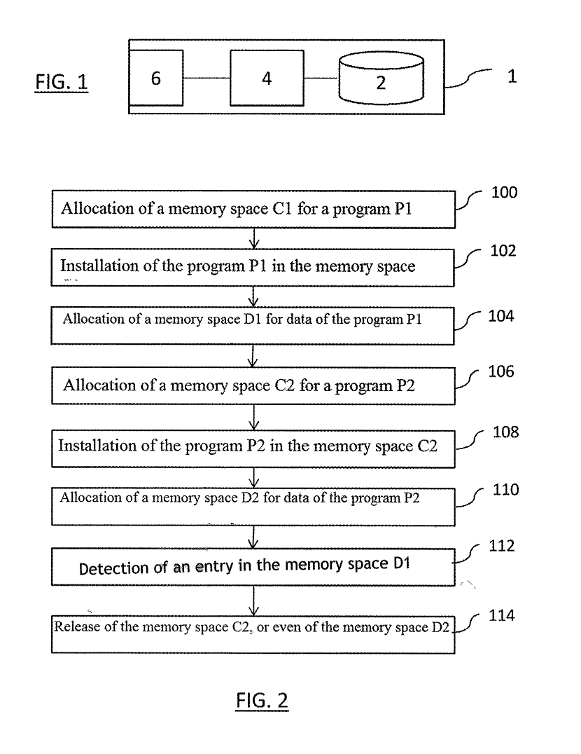

With reference to FIG. 1, an electronic card 1 comprises a memory 2, at least one processor 4, and a communication interface 6.

The memory 2 comprises one or more memory units suitable for storing program data. The memory 2 is for example a single memory unit of the flash type.

The processor 4 is suitable for executing program code instructions, and particularly accessing the content of the memory 2 in read and write mode or solely in read mode.

The electronic card 1 is provided with an operating system, the code instructions of which are stored in the memory 2 and can be executed by the processor 4. This operating system is a central program that controls the installation and execution of other programs, hereinafter referred to as application programs or applications.

In particular, the operating system is configured to define memory spaces isolated with respect to one another in the memory 2 (for example partitions).

Hereinafter, “memory space” means a set of bits, consecutive or not, in the memory 2, characterised by at least a pair of memory start and end addresses. It is considered that each bit in the memory can take two states in alternation: a “free” state, that is to say it is not used to represent data written in the memory, and an allocated state.

The communication interface 6 is connected to the processor 4. The processor 4 is also suitable for processing data received by the interface 6.

In one embodiment, the electronic card 1 is a personal authentication card, for example a bank card of a user. The electronic card 1 may then be in the form of a card of the UICC (universal integrated circuit card) type, or a SIM (subscriber identity module) card. The communication interface 6 of such a card is suitable for cooperating with a communication interface of a terminal, for example a bank transaction terminal or a user mobile terminal.

A description will now be given of a method for managing the memory 2 of the electronic card 1 with reference to the flow diagram of steps illustrated in FIG. 2.

In an initial state of the electronic card 1, the memory 2 contains only the code instructions of the operating system in a dedicated space referenced as OS. The memory 2 contains no application.

The following steps are implemented by the operating system when it is executed by the processor 4 of the electronic card 1.

In a step 100, the operating system allocates, in the memory 2, a memory space C1 intended to contain an application P1.

In a step 102, the operating system demands the installation of an application P1 in the memory space C1 thus allocated. The application P1 is received by the processor 4 via the communication interface 6. At the end of step 102, code instructions of the program P1 are contained in the memory space C1, in the form of interpreted code or compiled code directly executable by the processor 4.

It will be understood that the application P1 has a size in bits less than or equal to the size in bits of the previously allocated memory space C1.

In a step 104, the operating system allocates, in the memory 2, a data memory space D1 intended to contain data particular to the application P1. These data will be written and read by the application P1 during its subsequent execution by the processor 4, via the operating system. These are for example data specific to a user of the application P1, and/or configuration data for the application P1 shared by a plurality of users of the application P1.

The memory space D1 is accessible selectively to the application P1.

The step 104 of allocating the data memory space D1 may be implemented before or after the installation 100 of the application P1 in the memory space C1.

In a step 106, the operating system allocates, in the memory 2, a memory space C2 intended to contain an application P2.

In a step 108, the application P2 is installed in the memory space C2 thus allocated. The application P2 is for example received by the processor 4 via the communication interface 6. At the end of step 108, code instructions of the program P2 are contained in the memory space C2, in the form of interpreted code or compiled code directly executable by the processor 4.

In a step 110, the operating system allocates, in the memory 2, a data memory space D2 intended to contain data particular to the application P2. These data will be written and read by the application P2 during its subsequent execution by the processor 4, via the operating system. These are for example data specific to a user of the application P2, and/or data for configuration of the application P2 shared by a plurality of users of the application P2.

The memory space D2 is accessible selectively to the application P2.

The step 110 of allocating the data memory space D2 may be implemented before or after the installation 106 of the application P2 in the memory space C2.

Steps 100, 102, 104, 106, 108, 110 are typically performed during a phase of configuration of the electronic card in the factory, before it is sold and before any use by a user.

Each allocation step 100, 104, 106, 110 may comprise a positioning of the bits of the corresponding memory space C1, D1, C2, D2 at a reference value, so as to indicate that these bits are not yet used. For example, each byte of the memory space in question is positioned at zero.

Logic information representing a relationship between a plurality of applications is stored in the memory. The example of the existence in the memory of information between the applications P1 and P2 will be taken hereinafter.

This logic information may be written in the space OS during the phase of configuration of the electronic card 1 in the factory or be pre-programmed.

The logic information may be of various types.

A first type of logic information indicates the existence of a common function, or an identical service rendered by the applications that this logic information links.

For example, the two applications P1 and P2 are intrinsically configured to render an identical service to a user of the electronic card 1 when they are executed by the processor 4. Hereinafter, the example of two banking applications supplied by two competing suppliers will be taken; the identical service implemented by the two applications is in this case a bank transaction service.

A second type of logic information is a link of dependency between a plurality of programs. This second type of information may for example comprise a reference program, and at least one other third program, or dependent program, which would be both present in the memory 2 and configured to demand execution of the reference program. The reference program is in other words required for executing each third program.

It is also considered that the operating system has knowledge of the character, blank or not, of each allocated memory space, in particular data memory spaces D1 and D2. This knowledge may be represented by a bit in the memory OS, positionable at 1 in order to indicate the blank character of a given memory space, and positionable at 0 to indicate that this memory space is no longer blank, that is to say that it contains useful data.

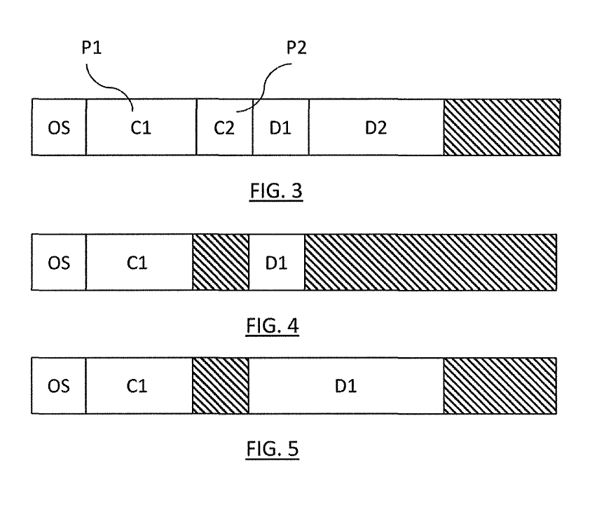

The content of the memory 2 is shown schematically in FIG. 3 after the implementation of steps 100, 102, 104, 106, 108 and 110. At this stage, the data memory spaces D1 and D2 are considered to be blank by the operating system.

It is considered hereinafter that a user comes into possession of the electronic card 1 that has been personalised and is sold to use solely the banking application P1, which makes the banking application P2 unused.

The user therefore does not need to use the application P2.

In a step 112, the operating system detects a first writing in the data memory space D1. This first writing occurs typically during a first execution of the program P1 by the processor 4, on command from the user of the electronic card 1. This first use in fact triggers the saving of data in the memory space D1 for the first time (personal data of the user and/or global configuration data having an effect during subsequent executions of the application P1).

The detection step 112 comprises the identification of the program associated by rights with the space D1 (it is a case here of the program P1). In the present embodiment, only the program P1 has access to the space D1, and it is therefore easy to deduce that the data written in D1 were written on instruction from the program P1.

The identification step 112 further comprises the search for at least one item of logic information stored in the memory 2 that would link the identified program P1 with another program of the aforementioned first type.

The detection is considered to be positive if at least one item of information of the first type indicating that the program P1 and another program render an identical service is found in the memory 2.

Otherwise the detection is considered to be negative.

In the example referred to by FIGS. 3 and 5, such logic information, indicating that the program P1 and the program P2 render an identical service, is found in memory; the detection is then considered to be positive.

In response to a positive detection 112, in a step 114, the operating system automatically releases the memory space C2 containing the code instructions of the application P2, which is competing with the application P1.

The memory space D2 may also be released in step 114. The release of the space D2 may be implemented selectively in the event of success of the release of the space C2.

This release 114 comprises for example the marking, in a mapping table controlled by the operating system, of the fact that the area of the memory 2 that was occupied by the memory space C2 and the one occupied by the memory space D2 are at present available for a future allocation by the operating system (for example to install a third application). After the release 114, the content of the memory 2 is as depicted in FIG. 4.

After the release 114, a new memory space may be allocated in all or part of the area or areas of the memory 2 released.

The new memory space may be made accessible to the first program (P1).

This new memory space may be contiguous with the memory space D1 previously usable by the program P1, as depicted in FIG. 3; in this case, a processing consisting of logic merger of the memory space D1 and the new memory space may be provided, a merger that corresponds to an extension of the memory space D1 to the area released during step 112, as depicted in FIG. 5, and/or to the area released during step 114.

In the embodiment described previously, the detection 112 uses only the first type of logic information (indicating common services between programs).

In a variant, the first type of logic information (indicating services common between programs) and the second type of logic information (information on dependency between programs) are combined. In this variant, a release of memory space may be implemented only if the following two conditions are met:
information of the first type indicating that the program P1 and another program render an identical service is found in the memory 2, and
no information of the second type mentions this other program (here P2) as a reference program able to be invoked by a third program.

In this case, the release 114 of the program P2 is implemented.

On the other hand, if one or other or both of the two conditions is not met, the detection is negative, and the release of the program P2 is not implemented.

Moreover, provision may also be made for using the second type of logic information for automatically deleting all the programs that are made inoperative following the release of the space C2 (and therefore the tacit elimination of the program P2).

This may be implemented by a search for logic information of the second type that mentions the program P2 as a reference program. For each item of logic information of the second type found, the memory area containing the third program code identified by this logic information is released.

When the electronic card 1 is embedded in and/or cooperates with a terminal comprising entry means, the step 112 of releasing a program stored in the memory 2 may also be triggered in response to the acquisition, by the entry means, of data representing a command to delete the corresponding program.

In the embodiment illustrated in FIGS. 3 to 5, the data areas D1 and D2 are shown as being separate.

In a variant, a data area D accessible not specifically to a program but to (at least) the two programs P1 and P2 is allocated, this allocation corresponding to steps 104 and 110 (then D=D1 U D2).

In this variant, the detection step 112 may comprise an identification of the program that demands or has demanded the writing (P1 in the preceding case), before proceeding with a search for logic information mentioning this program identified.

The present invention is not limited to a method applied to banking applications; applications of other types may be the subject of the method described above, provided that they render an identical service.

1. Method for managing a memory of an electronic card, the electronic card being able to execute a first program and a second program, the method comprising steps of:
allocating in the memory, a first memory space accessible to the first program,
allocating in the memory, a second memory space storing the code of the second program,
the method being characterised by steps of:
detecting a first data entry on instruction from the first program in the first memory space,
release of the second memory space in response to the detection.

2. Method according to claim 1, in which the first memory space is accessible selectively to the first program.

3. Method according to claim 1, comprising the determination of information indicating whether or not the first program and the second program implement an identical service, the release being selectively implemented if the information indicates that the two programs both implement an identical service.

4. Method according to claim 1, in which the identical service is a bank transaction service.

5. Method according to claim 1, also comprising a detection of any third program stored in the memory and configured to demand execution of the second program, the release of the second space being selectively implemented if no third program is detected.

6. Method according to claim 1, further comprising the allocation, in the area of the memory made available by the release the second memory space, of a third memory space accessible to the first program.

7. Computer program product comprising program code instructions for executing the steps of the method according to claim 1, when this program is executed by a processor.

8. Electronic card comprising:
at least one processor suitable for executing a first program and a second program, the two programs implementing an identical service,
a memory comprising:
a first memory space accessible to the first program,
a second memory space storing the code of the second program,
the electronic card being characterised by the fact that the processor is configured to:
detect a first data entry in the first memory space caused by the first program in the first memory space, and
demand the release of the second memory space in response to the detection.

9. Electronic card according to claim 8 in which the memory is of the flash or EEPROM type.

10. Use of an electronic card according to claim 8 as a personal authentication card.
